(19) United States
(12) Patent Application Publication
(10) Pub. No.: US 2010/0065638 A1
(43) Pub. Date: Mar. 18, 2010

(54) BARCODE READER MODULE FOR RECOGNIZING RFID TO BE LOADED AN RUGGED PDA

(76) Inventor: Seong-soo Kim, Gyeonggi-do (KR)

Correspondence Address: North Star Intellectual Property Law, PC, P.O. Box 34688, Washington DC, DC, 20043, US

(21) Appl. No.: 12/513,588

(22) PCT Filed: May 16, 2008
(86) PCT No.: PCT/KR2008/002732

§ 371 Date: May 5, 2009

(30) Foreign Application Priority Data
May 18, 2007 (KR) 10-2007-0048795

(51) Int. Cl. G06K 17/00

(52) U.S. Cl. 235/440; 235/462.13

(57) ABSTRACT

Provided is a barcode reader module having a Radio Frequency Identification (RFID) function, which is loaded on a mobile terminal. The barcode reader module includes: a camera unit reading a barcode symbol containing information; an antenna integrated with the camera unit; an RFID signal transmitting/receiving unit transmitting/receiving an RFID signal through the antenna; and a signal processor processing an analog signal received from the RFID signal transmitting/receiving unit or from the camera unit, and outputting the result of the processing to the outside.

### TECHNICAL FIELD

The present invention relates to a barcode reader module for recognizing Radio Frequency Identification (RFID) to be loaded on a mobile terminal such as a rugged Personal Digital Assistant (PDA).

### BACKGROUND ART

A Personal Digital Assistant (PDA), which is a type of a portable computer, is a portable personal information terminal which stores text files written by a computer in home or office and has personal information management or scheduling applications, like an electronic organizer. Although a PDA has been used only for limited applications such as calculating or scheduling, recently, it is in the spotlight as a representative information and communication appliance of a post PC with the rapid development of information and communication technologies.

A Radio Frequency Identification (RFID) technology is used widely in various applications, such as payment of transportation costs, various automation projects, businesses of distribution, livestock management, entrance control, conduct management, physical distribution management, parking management, and financial management. In general, a module with an RFID function includes a memory chip and an inlay which is a coil surrounding the memory chip. When a target is within a pre-determined distance from the module, an inductive magnetic field is generated in the inlay of the module and a value stored in the memory chip of the module is transmitted.

A barcode reader module is an optical reader for converting a barcode symbol into an electrical signal, generally, using an optical recognition method. Conventionally, one-dimensional (1D) bar-type barcodes have been widely utilized which can be recognized by laser scanner modules which read barcodes using light reflection. However, recently, in order to resolve disadvantages of such 1D barcodes, that is, inaccuracy, a large symbol size, a small amount of information, two-dimensional (2D) barcodes have been proposed. In order to recognize 2D barcodes, a camera scan method is adopted and used.

However, recently, with the development of communication industries, a requirement for a mobile terminal equipped with a module having an RFID function and a module using a camera scan method is increasing. However, in order to manufacture a mobile terminal which meets the requirement, a large number of components should be installed in the mobile terminal, which increases an assembly time and accordingly deteriorates productivity, resulting in an increase of manufacturing costs. Also, due to generation of lots of unnecessary spaces, the size of a barcode scanner increases.

### DISCLOSURE OF INVENTION

### Technical Problem

Therefore, according to an aspect of the present invention, there is provided a barcode reader module having a Radio Frequency Identification (RFID) function, which can reduce the number of required components, remove unnecessary spaces, have a small size, and reduce an assembly time, thereby enhancing productivity.

Accordingly, according to another aspect of the present invention, there is provided a barcode reader module having an RFID function, which can increase a recognition rate for a barcode by capturing a barcode symbol image with high picture-quality.

### TECHNICAL SOLUTION

The present invention provides a barcode reader module having a Radio Frequency

Identification (RFID) function, including: a camera unit reading a barcode symbol containing information; an antenna integrated with the camera unit; an RFID signal transmitting/receiving unit transmitting/receiving an RFID signal through the antenna; and a signal processor processing an analog signal received from the RFID signal transmitting/receiving unit or from the camera unit, and outputting the result of the processing to the outside.

The barcode reader module further includes an aiming pattern generator aiming a predetermined pattern as an area smaller than an imaging range of a lens of the camera unit on the barcode symbol which a user wants to read. Here, the aiming pattern generator may be a lens system including a laser diode for applying light, and a pattern lens for refracting the light applied by the laser diode and thus forming a pre-determined aiming pattern.

Additional features of the invention will be set forth in the description which follows, and in part will be apparent from the description, or may be learned by practice of the invention.

### ADVANTAGEOUS EFFECTS

According to an aspect of the present invention, by integrating a baseband circuit of a barcode module with a baseband circuit for RFID, it is possible to reduce the number of required components, to save a space for installing the modules therein, and to reduce manufacturing costs.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a perspective view of a barcode reader module having a Radio Frequency Identification (RFID) function, according to an embodiment of the present invention.

FIG. 2 is a perspective view of a barcode reader module having an RFID function, according to another embodiment of the present invention.

FIG. 3 is a block diagram of a barcode reader module having an RFID function, according to an embodiment of the present invention.

### MODE FOR THE INVENTION

The invention is described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

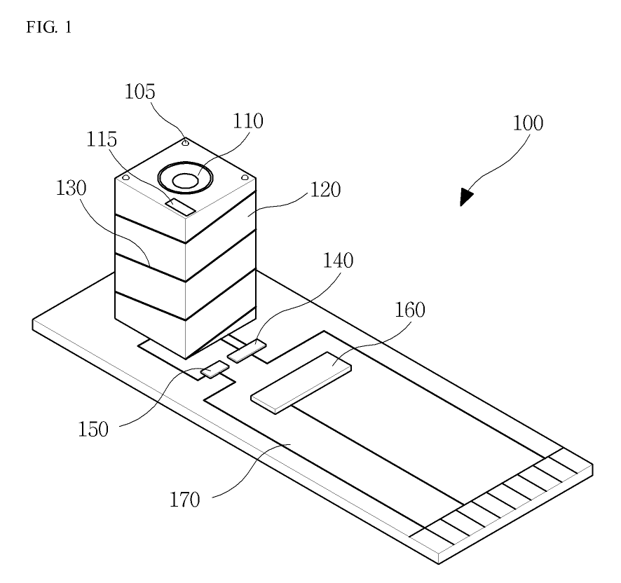

FIG. 1 is a perspective view of a barcode reader module 100 having a Radio Frequency Identification (RFID) function, according to an embodiment of the present invention.

Referring to FIG. 1, the barcode reader module 100 includes one or more lighting units 105 for applying light on a barcode symbol containing information when a camera unit is turned on, a camera lens 110 and a camera casing 120 constructing the camera unit for reading the barcode symbol containing the information, an antenna 130, an RFID signal transmitting/receiving unit 140 for transmitting/receiving RFID signals through the antenna 130, a signal converting unit 150 for converting an analog signal received from an image sensor (not shown) of the camera unit into a digital signal, a module processor 160, and a flexible printed circuit board (FPCB) 170.

The camera lens 110 is exposed out of the camera casing 120, and an antenna pattern is formed on the outer surface of the camera casing 120. The antenna 130 is used to receive and transmit radio frequency signals, and installed in the camera casing 120. As illustrated in FIG. 1, in the current embodiment, the antenna 130 may be a helical conductive line which surrounds the outer sides of the camera casing 120.

The module processor 160 outputs a command for reading the barcode symbol, which is received from a host processor of a Personal Digital Assistant (PDA), to the camera unit, and outputs a code value of the barcode symbol read by the camera unit to the host processor. A reference number 115 denoted in FIG. 1 is an aiming pattern generator which aims a predetermined pattern as an area smaller than the imaging range of the camera lens 110 on the barcode symbol which a user wants to read. The configuration of the aiming pattern generator 115 will be described later.

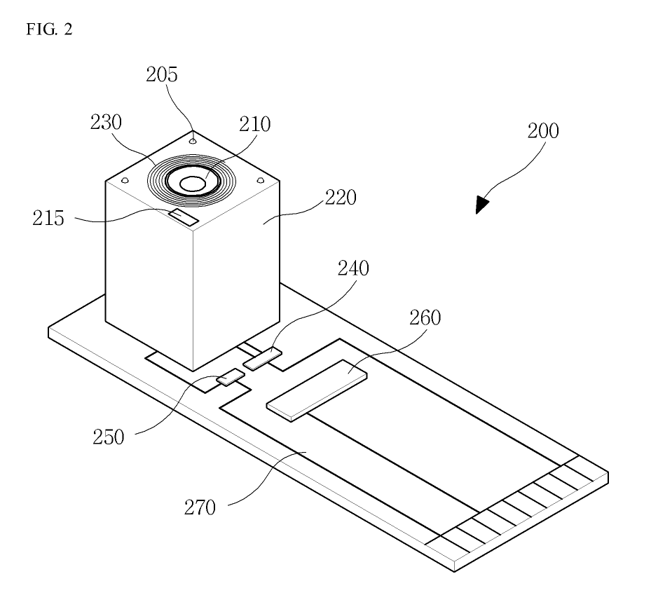

FIG. 2 is a perspective view of a barcode reader module 200 having an RFID function, according to another embodiment of the present invention.

Referring to FIG. 2, the barcode reader module 200 includes one or more lighting units 205 for applying light on a barcode symbol containing information when a camera unit is turned on, a camera lens 210 and a camera casing 220 constructing the camera unit for reading an image of the barcode symbol containing the information, an antenna 230, an RFID signal transmitting/receiving unit 240 for transmitting/receiving RFID signals through the antenna 230, a signal converting unit 250 for converting an analog signal received from an image sensor (not shown) of the camera unit into a digital signal, a module processor 260, and a flexible printed circuit board (FPCB) 270.

According to an embodiment of the present invention, the antenna 230 can be formed in the shape of a patch along the outer circumference of the camera lens 210 on one side of the camera casing 220. That is, the camera lens 210 can be included in a part (or an inner part) of an RFID patch antenna. The module processor 260 outputs a command for reading a barcode symbol, which is received from a host processor of a PDA, to the camera unit, and outputs a code value of the barcode symbol read by the camera unit to the host processor. A reference number 215 denoted in FIG. 2 is an aiming pattern generator which aims a predetermined pattern as an area smaller than the imaging range of the camera lens 210 on the barcode symbol which a user wants to read. The configuration of the aiming pattern generator 215 will be described later.

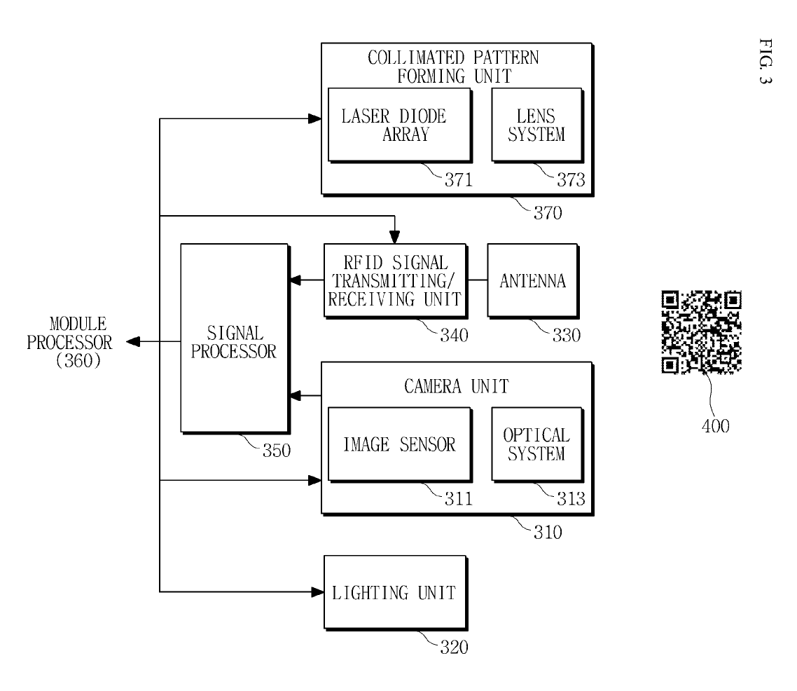

FIG. 3 is a block diagram of a barcode reader module having an RFID function, according to an embodiment of the present invention.

Referring to FIG. 3, the barcode reader module includes a camera unit 310, a lighting unit 320, an antenna 330 installed on the casing of the camera unit 310, an RFID signal transmitting/receiving unit 340 for transmitting and receiving RFID signals through the antenna 330, a signal processor 350, and a module processor 360.

The camera unit 310 is used to read a barcode symbol 400 containing information. In the current embodiment, the camera unit 310 includes one or more small-sized lenses, an optical system 313 for condensing light, and an image sensor 311 for converting an optical signal received from the optical system 313 into an analog electrical signal. The image sensor 311 may be a CMOS or CCD imaging device, and converts light into electrical signals for each pixel, synchronizes the electrical signals to a clock signal, and then outputs the resultant signals sequentially. The image sensor 311 is well known to those skilled in the art, and therefore a detailed description thereof is omitted.

The lighting unit 320 applies light to the barcode symbol containing the information when the camera unit 310 is turned on. The lighting unit 320 may be a Light Emitting Diode (LED), such as an InfraRed Emitting Diode (IRED), a Visible Light Emitting Diode (VLED), an Ultraviolet Light Emitting Diode (UV LED), or an Organic Light Emitting Diode (OLED). For example, the lighting unit 320 is molded and integrated into the casing of the camera unit 310, or mounted separately on a printed circuit board.

The RFID signal transmitting/receiving unit 340 transmits/receives RFID signals through the antenna 330, and includes a radio frequency signal transmitting circuit including a counter, a baseband filter (BPF), and a power amplifier; and a radio frequency signal receiving circuit including a baseband filter (BPF) and a frequency synthesizer.

The signal processor 350 converts the analog signal received from the RFID signal transmitting/receiving unit 340 or the camera unit 310 into a digital signal, and outputs the digital signal to the module processor 360. The module processor 360 outputs a command for reading the barcode symbol, which is received from a host processor of a PDA, to the camera unit 310, and outputs a code value of the barcode symbol read by the camera unit 310 to the host processor. Also, the module processor 360 recognizes a radio frequency signal on the basis of the data received from the signal processor 350. According to an embodiment of the present invention, the signal processor 350 includes a peak detector for determining a peak-time and amplitude of the analog signal received from the RFID signal transmitting/receiving unit 430, an automatic gain controller (AGC), a gain and filter, and a digitizer. According to another embodiment of the present invention, the signal processor 350 includes a converting unit for converting a current or voltage which is proportional to the brightness of an image received from the image sensor 311 of the camera unit 210, into digital data, and converting a value of the digital data into a YUV data format.

According to another embodiment of the present invention, the barcode reader module further includes an aiming pattern generator 370 which aims a predetermined pattern as an area smaller than the imaging range of the camera lens 210 on the barcode symbol which a user wants to read.

The aiming pattern generator 370 includes a laser diode 371 for applying light, and a lens system 373 including a pattern lens for refracting the light applied by the laser diode 371 and thus forming a predetermined aiming pattern. Here, the pattern aiming on the barcode symbol through the pattern lens may be a square having four corners. The optical system 313 of the camera unit 310 can be automatically focused when the pattern lens aims light.

As described above, the barcode reader module having the RFID function, according to the embodiment of the present invention, can reduce the entire size by a space corresponding to an antenna, and efficiently utilize the inner space, compared to a conventional barcode reader in which a module having a RFID function is separated from a camera module, thereby enhancing productivity and reducing manufacturing costs.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

A barcode reader module having an RFID function, according to the present invention, can be efficiently applied to various mobile terminals.

1. A barcode reader module having a Radio Frequency Identification (RFID) function, comprising:
a camera unit reading a barcode symbol containing information;
an antenna integrated with the camera unit;
an RFID signal transmitting/receiving unit transmitting/receiving an RFID signal through the antenna; and
a signal processor processing an analog signal received from the RFID signal transmitting/receiving unit or from the camera unit, and outputting the result of the processing to the outside.

2. The barcode reader module of claim 1, further comprising an aiming pattern generator aiming a predetermined pattern as an area smaller than an imaging range of a lens of the camera unit on the barcode symbol which a user wants to read.

3. The barcode reader module of claim 1, further comprising a lighting unit applying light on the barcode symbol containing the information when the camera unit is turned on.

4. The barcode reader module of claim 1, further comprising a module processor outputting a command for reading the barcode symbol, which is received from a host processor, to the camera unit, and outputting a code value of the barcode symbol read by the camera unit to the host processor.

5. The barcode reader module of claim 1, wherein the antenna is formed in a shape of a patch on one side of a casing of the camera unit along an outer circumference of a lens of the camera unit.

6. The barcode reader module of claim 1, wherein the antenna is formed on outer sides of a casing of the camera unit.
